(19) United States
(12) Patent Application Publication
(10) Pub. No.: US 2024/0279032 A1
(43) Pub. Date: Aug. 22, 2024

(54) AUTONOMOUS LOAD COUPLING AND ORIENTATION APPARATUS AND REMOTE LOCKING SYSTEM AND ASSOCIATED METHODS

(71) Applicant: Helerich & Payne Technologies UK Limited, Inverness (GB)

(72) Inventor: Angus Lamberton Jamieson, Inverness (GB)

(21) Appl. No.: 18/443,088

(22) Filed: Feb. 15, 2024

Related U.S. Application Data
(60) Provisional application No. 63/485,354, filed on Feb. 16, 2023.

(51) Int. Cl. B66C 13/08; B66C 13/40

(52) U.S. Cl. CPC B66C 13/08; B66C 13/40

(57) ABSTRACT

A remote load coupling and orientation control apparatus according to aspects of the present disclosure may include a closed loop tank assembly. The closed loop tank assembly can include a plurality of tank modules. A fluid may be positioned within the tank modules of the closed loop tank assembly. The remote load coupling and orientation control apparatus may also include a propulsion device for controlling a direction and a speed of the fluid positioned within the closed loop tank assembly, as well as a plurality of locking systems for coupling the remote load coupling and orientation control apparatus to a load. The apparatus may include a power source for powering the propulsion device and a controller for controlling a position of the plurality of locking systems.

### CROSS-REFERENCE TO RELATED APPLICATIONS

This application claims the benefit of priority to U.S. Provisional Application Ser. No. 63/485,354 filed Feb. 16, 2023, the entire contents of which is incorporated herein in its entirety.

This application is related to the commonly assigned U.S. patent application Ser. No. 18/537,660, filed Dec. 12, 2023, entitled Systems and Method for the Lifting of a Load, the disclosure of which is incorporated herein by reference in its entirety for all purposes.

### TECHNICAL FIELD

The present application relates to load coupling, lifting, and positioning apparatus including methods for remotely coupling to a load for lifting and controlling the orientation of the lifted load remotely.

### BACKGROUND OF THE INVENTION

Loads can be suspended by forklifts, wheel loader overhead cranes such as boom and jib cranes and many other machines that can lift a load higher than ground level. Current load coupling, lifting, handling, and positioning systems involve ground workers manually connecting the load to the lifting device or apparatus and dragging the load via the guide ropes into a desired position. In addition, ground workers often manually use guide ropes to control the positioning of the load, which can be dangerous in many situations such as high weather which can cause the load to move/rotate. This handling operation can be problematic due to the physically demanding nature of the equipment especially when the work is carried out under adverse weather conditions. Problems can also occur when there is miscommunication between the crane operator and ground workers. Such issues can result in collision of the load with obstacles leading to damage of the load and/or the obstacles and risks to personnel. Operators of lifting machinery, such as cranes, sometimes have limited control to maneuver the overhanging load and accurately position the load in a desired orientation before it is lowered.

Most accidents on onshore and offshore sites are related to load coupling, lifting, and handling. During connection and disconnection of a load to a locking apparatus such as a crane, accidents may occur due to external forces such as such as inclement weather. High winds may cause the load to move and change orientation. This can be problematic for crane operators trying to maintain a stable position whilst the load is connected/disconnected to the lifting device.

There is a high risk of serious injury or death if a suspended load should fall during handling operations. Due to the need to securely connect the load to the locking apparatus and the nature of the use of guide ropes to orient the load, the workers are required to be in close proximity of the load and are therefore at an increased risk of danger. The level of danger increases as the weight and size of the load increases. Due to the complexity of the handling operation and the safety protocols for the on-site workers, any operation requiring the connection/disconnection and movement of loads must be pre-planned to ensure that at no point a worker is required to work in proximity to the suspended load. This can impose restrictive working conditions when the area to maneuver the load is small.

It is the object of some aspects of the present invention to obviate or at least mitigate the foregoing disadvantages of prior art load handling systems. It is an object of some aspects of the present invention to provide an apparatus or system which is designed for easy and rapid connection and disconnection of a load to and from a lifting device remotely. It is another object of some aspects of the present invention to provide an apparatus or system configured to enable a crane operator to remotely connect and disconnect a lifting device to a load. It is another object of some aspects of the present invention to provide an apparatus or system configured to accurately control the positioning of a load and to allow the crane operator to maintain full control of the orientation of the load. A further object of some aspects of the present invention is to reduce the risk of injury to on-site workers who work in close proximity to the load handling apparatus. Further aims of certain aspects of the present invention will become apparent from the following description.

### SUMMARY OF THE INVENTION

According to an aspect of the present disclosure, there is provided a remote load coupling and orientation control apparatus including a closed loop tank assembly comprising a plurality of tank modules, wherein a fluid is positioned within the tank modules of the closed loop tank assembly. The assembly may also include a propulsion device for controlling a direction and a speed of the fluid positioned within the closed loop tank assembly for controlling the orientation of the load when lifted, as well as for controlling the orientation or position of the load upon lowering of the load. The assembly may also include a plurality of locking systems for coupling the remote load coupling and orientation control apparatus to a load. The assembly may also include a power source for powering the propulsion device and a controller for controlling a position of the plurality of locking systems. The assembly may further include a plurality of guide features movable between a storage position and a deployed position, wherein the guide features are configured to aid in positioning the remote load coupling and orientation control apparatus for remote coupling to the load via the plurality of locking systems.

In some aspects, the apparatus may further include a connection housing, wherein the controller for controlling the position of the plurality of locking systems is positioned within the connection housing. In still yet some aspects, the remote load coupling and orientation control apparatus may include the controller being also communicatively coupled to the propulsion device for controlling the propulsion device. In some aspects, the remote load coupling and orientation control apparatus may also include another controller that is communicatively coupled to the propulsion device for controlling the propulsion device. In some aspects, the remote load coupling and orientation control apparatus may include each locking systems of the plurality of locking system further comprising a locking body, an actuator, a lever, and a gear, wherein, the lever is coupled between the actuator and the gear such that the lever rotates in response to the actuation of the actuator, and wherein the gear is coupled between the locking body and the lever such that the locking body moves in response to the rotation of the lever, and wherein the locking body is movable between a first position and a second position in response to the actuation of the actuator.

In some aspects, the remote load coupling and orientation control apparatus may also include the actuator being positioned within a connection housing. In some aspects, the power source may be a battery. In some aspects, the propulsion device may be an impeller. In some aspects, the closed loop tank assembly comprises at least one generally curved tank module and at least one generally rectangular tank module. The remote load coupling and orientation control apparatus of may further comprising a power source for powering the propulsion device.

The remote load coupling and orientation control apparatus may further comprise a frame member coupled to the closed loop tank assembly. In some aspects, the closed loop tank assembly defines a frame member. The apparatus may further include a transmitter for transmitting a wireless signal to a device, wherein the wireless signal corresponds to a position of an element of the remote load coupling and orientation control apparatus. The apparatus may further include a receiver for receiving a wireless signal from a device, wherein the wireless signal corresponds to instructions for operation of the remote load coupling and orientation control apparatus.

According to an aspect of the present disclosure, a method of connecting a remote load coupling and orientation control apparatus to a load may include the step of providing a remote load coupling and orientation control apparatus comprising a closed loop tank assembly comprising a plurality of tank modules, wherein a fluid is positioned within the closed loop tank assembly, the apparatus may also include a propulsion device for controlling a direction and a speed of the fluid positioned within the closed loop tank assembly, a power source for powering the propulsion device, and a plurality of locking systems for coupling the remote load coupling and orientation control apparatus to a load. The method may include positioning the remote load coupling and orientation control apparatus such that each locking system is positioned within a chamber of the load and actuating each lifting connection from an unsecured position to a secured position within the chamber, as well as the step of lifting the load by lifting the remote load coupling and orientation control apparatus when each locking system is in the secured position such that the remote load coupling and orientation control apparatus is coupled to the load. The method may further include activating the propulsion device for controlling the orientation of the lifted load. In some aspects, the apparatus may include a propulsion device that an impeller or a propeller. The apparatus may also include the remote load coupling and orientation control apparatus further having a frame member coupled to the closed loop tank assembly. In some aspects, the step of the method of actuating the propulsion device for controlling the orientation of the lifted load further includes receiving, by a transceiver, a signal from a remote device corresponding to an instruction to rotate the propulsion device in a desired direction at a desired rate and sending, by a controller, a signal to the propulsion device to rotate in the desired direction at the desired rate. The method may include the additional step of detecting the position of the locking systems and transmitting a wireless signal to a remote device, the wireless signal corresponding to the position of the lifting connection, and the additional step of displaying an indication on the remote device corresponding to the position of the lifting connection. The method may include having the indication being one or more of an illuminated light, a sound, or an electronic message. In some aspects, the remote device is a mobile telephone, a handheld device, a computing device, or the remote device is integrated with a machine for lifting of the load.

According to an aspect of the present disclosure, a load coupling and orientation control apparatus comprising a closed loop tank assembly, wherein a fluid is positioned within the closed loop tank assembly; a propulsion device for controlling a direction and a speed of the fluid positioned within the closed loop tank assembly to thereby control orientation of the closed loop tank assembly; and a plurality of locking systems for coupling the load coupling and orientation control apparatus to a load. In some aspects, the apparatus may further include a controller coupled to the propulsion device and adapted to receive and send wireless signals to a remote control device. In some aspects, the apparatus may comprise the closed loop tank assembly comprising a plurality of tank modules connected to one another. In some aspects, the closed loop tank assembly may have a generally rounded rectangular shape, a generally circular shape, or a generally elliptical shape. In some aspects, the load coupling and orientation control apparatus of claim 26, wherein the propulsion device comprises a propeller, an impeller, a plurality of propellers, a plurality of impellers, or a combination of one or more propellers and one or more impellers. In some aspects, the load coupling and orientation control apparatus may be adapted to move in a counterclockwise direction in response to movement of the fluid in a clockwise direction. In some aspects, the load coupling and orientation control apparatus may be adapted to move in a clockwise direction in response to movement of the fluid in a counterclockwise direction.

### BRIEF DESCRIPTION OF THE DRAWINGS

For a more complete understanding, reference is now made to the following description taken in conjunction with the accompanying Drawings in which:

FIG. 1 depicts a schematic view of a worksite including a load coupling and orientation control apparatus coupled between a lifting machine and a load to be lifted.

FIG. 2 depicts a top perspective view of a load coupling and orientation control apparatus according to aspects of the present disclosure with guide features in an extended position.

FIG. 3 depicts a top perspective view of the load coupling and orientation control apparatus of FIG. 1 according to aspects of the present disclosure with guide features in a retracted position.

FIG. 4 depicts a top perspective view of a load coupling and orientation control apparatus according to aspects of the present disclosure.

FIG. 5 depicts the top perspective view of the load coupling and orientation control apparatus of FIG. 4, according to aspects of the present disclosure, coupled to a load.

FIG. 6 depicts a bottom perspective view of the load coupling and orientation control apparatus of FIG. 2.

FIG. 7A depicts a locking system in an unsecured position within an opening of a load

FIG. 7B depicts the locking system of FIG. 7A in a secured position in the opening of the load.

FIG. 8 depicts an elevation view of the locking system of FIGS. 8A, 8B in an unsecured position.

FIG. 9 depicts an end elevation view of a portion of the locking system depicted in FIGS. 7A-7.

FIG. 10A depicts a locking system in an unsecured position within an opening of a load

FIG. 10B depicts the locking system of FIG. 10A in a secured position in the opening of the load.

FIG. 11 depicts an end elevation view of the locking system of FIGS. 10A, 10B in an unsecured position.

FIG. 12 depicts a non-limiting example of a computer system according to aspects of the present disclosure.

### DETAILED DESCRIPTION

Referring now to the drawings, wherein like reference numbers are used herein to designate like elements throughout, the various views and embodiments and an apparatus and method for a load coupling and orientation control apparatus are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

In some embodiments of the present invention, a load coupling and orientation control apparatus may include a closed loop tank assembly made up of a plurality of tank modules. The load coupling and orientation control apparatus may also provide for remote coupling between the apparatus and the load to be lifted and oriented. A fluid, such as water, may be positioned within the closed loop tank assembly. A propulsion device such as an impeller or propeller may be positioned within the closed loop tank assembly for controlling circulation of the fluid in a desired direction at a desired speed. The propulsion device may be controlled by a battery unit or other electrical component. The battery unit or other electrical component may also include a control unit that controls the direction and speed the propulsion device rotates in the tank assembly. The load coupling and orientation control apparatus may be a remote load coupling and orientation control apparatus that may be coupleable to a load without manual connection by an on the ground worker.

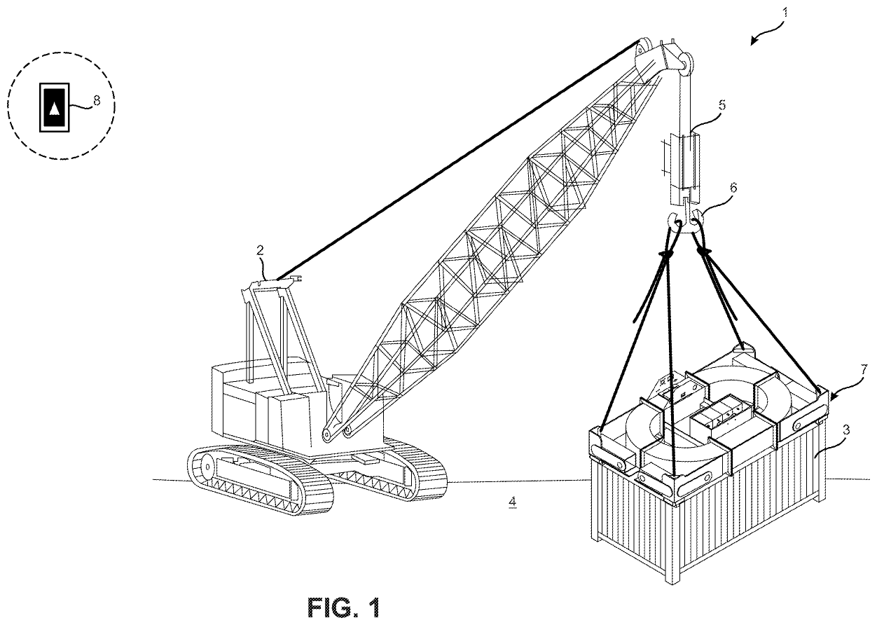

Referring to FIG. 1, a work site 1 is provided that includes a lifting machine 2, for example but not limited to a crane as shown in FIG. 1. While FIG. 1 depicts a crane, the present disclosure contemplates the use of any suitable machinery that can be used to lift a load 3, such as lifting a load 3 off the ground 4, off a truck, train car, cargo ship, a building site above ground (e.g., a third floor of a building being built), a top of a building, or any other location on which the load 3 might be located. The lifting machine 2 may include a coupling line 5 which may be a wire rope, chain, or other suitable rigging feature. A coupling feature 6 such as a hook, carabiner, closed loop, or other suitable feature may be positioned adjacent an end of the coupling line 5. To provide for remote coupling to the load 3 and to further provide for control of the orientation of the load 3 when it is lifted and subsequently lowered, the load 3 may be coupled to a load coupling and orientation control apparatus 7, instead of coupling the load 3 directly to the lifting machine 2. In some aspects of the present disclosure the load coupling and orientation control apparatus 7 may be coupleable to the load 3 remotely via one or more locking systems (not shown). In other words, the locking systems may provide for coupling between the load 3 and the apparatus 7 via remote controlling of the position and/or actuation of the locking systems without requiring direct manual connection between the apparatus 7 and the load 3. In other aspects of the present disclosure, the load 3 may be manually coupled to the apparatus 7, for example but not limited to via fastening features (e.g. hooks, loops, etc.) and rope wire or similar coupling lines. The load coupling and orientation control apparatus 7 may be coupled to the lifting machine 2 by additional coupling lines that couple to the lifting machine 2, for example via the coupling feature 6. The apparatus 7 may be first coupled to the lifting machine 2 and then subsequently coupled, including remotely, to the load 3. The load coupling and orientation control apparatus 7 when coupled to the load 3 and the lifting machine 2 may provide for control over the orientation of the load 3 when lifted, as described in further detail below. The load coupling and orientation control apparatus 7 may include one or more features of the non-limiting exemplary load coupling and orientation control apparatus 10 or 40 or any suitable combination of features of those examples.

Upon lifting, the orientation of the load 3 may be controlled remotely via the apparatus 7, for example via a user controlling a fluid flow through the apparatus 7 remotely via control system or unit (or controller) 8 as set forth further below and as in U.S. Pat. No. 10,207,903, entitled “Apparatus and Method for Controlling the Orientation of a Suspended Load” filed on Feb. 19, 2019, the entire contents of which is incorporated herein by reference. It should be noted that the foregoing discussion, while focused on a “lifting” machine 2, in most situations the lifting machine 2 may also be able to move the load 3 from a first location to a second location and to lower the load 3 as well as lift it. The apparatus 7 may thereby be used to control the position of the load 3 when lifted, for example to maintain a position of the load 3 (e.g. stop it from spinning), or to orient the load 3 in a desired orientation (e.g. position a first end of the load 3 in a desired position or orientation), the apparatus 7 may further control the position or orientation of the load 3 when the load 3 is lowered to provide for improved placement of the load 3 in its desired lowered location. For example, a load 3 comprising a shipping container may be oriented when lifted and lowered such that the shipping container is in a desired position relative to a location the container is being placed (e.g. on a ship, a dock, a truck, or the like) to provide for improved ease of placement and accuracy of placement of the load 3.

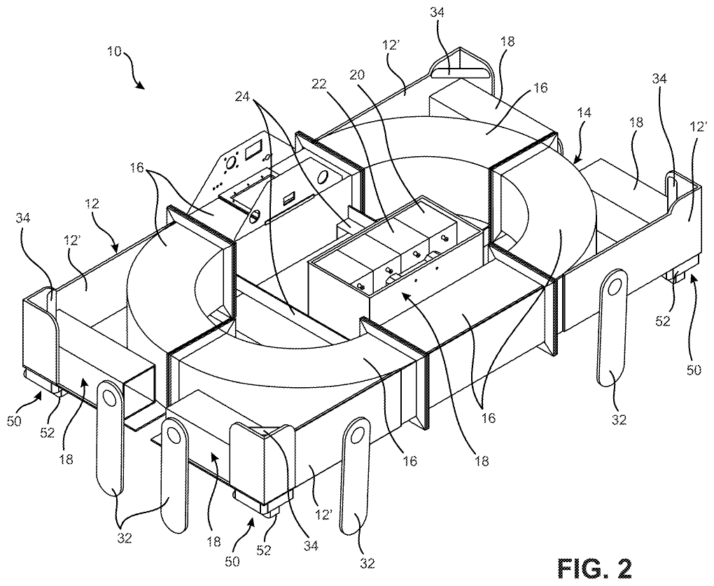

Referring to FIG. 2, a non-limiting embodiment of a load coupling and orientation control apparatus 10 is provided, the apparatus 7 in FIG. 1 may have some or all of the features described herein with respect to apparatus 10, 40. As depicted in FIG. 2, the apparatus 10 may include a frame 12 comprised of one or more frame members 12′ positioned at least partially externally to a closed loop tank assembly 14. The frame members 12′ may define an outer shape of the frame 12 that may be a lifting frame, the frame members 12′ may also define a base of the frame 12. In some aspects, the frame 12 may at least partially surround some or all of the closed loop tank assembly 14, for example to aid in reducing the total weight of the apparatus 10 the frame 12 may surround only a portion of the assembly 14. In some aspects, the frame 12 may have substantially the same outer perimeter size and shape as a top surface of the load to be lifted. For example the load may be an ISO shipping container and the frame 12 may have substantially the same outer perimeter size and shape as the ISO shipping container. The closed loop tank assembly 14 (or tank assembly) may be comprised of a plurality of tank modules 16.

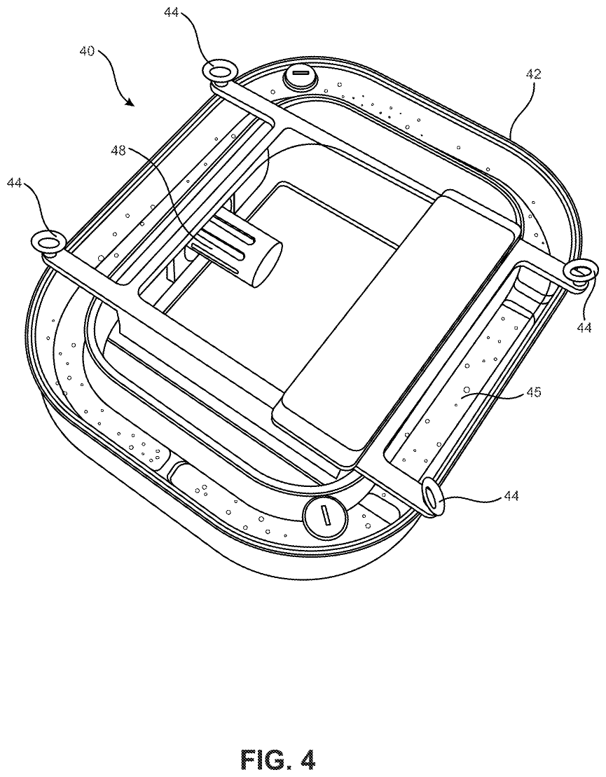

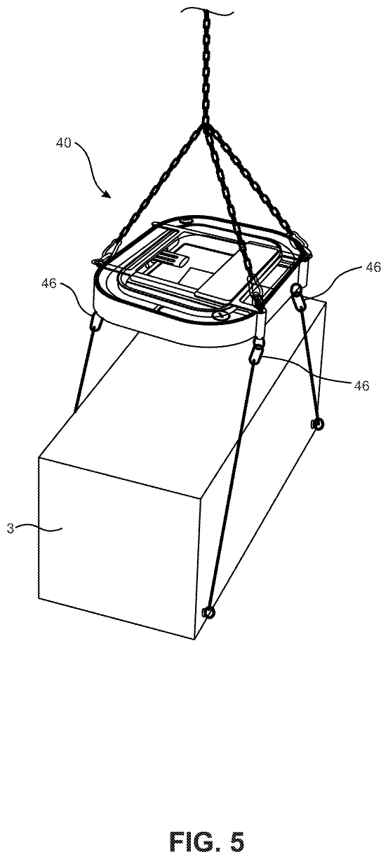

The tank modules 16 may, for example, have different sizes and shapes and may be coupled together to form the closed loop tank assembly 14. The size and shape of the closed loop tank assembly 14 may vary based on the size and shape of the frame 12 (and corresponding frame members 12′). The use of tanks modules 16 which may be assembled together for forming the closed loop tank assembly 14 can reduce the time and costs associated with manufacturing and assembling the closed loop tank assembly 14. In addition, using tanks modules 16 to form the closed loop tank assembly 14 can also provide for flexibility in the shape and size of the closed loop tank assembly 14 and can provide improved stock management for improving the speed at which tank assemblies 14 maybe assembled while minimizing the number of different parts/pieces/modules 16 that must be stored (e.g. kept in stock). The individual tank modules 16 may be assembled together via mechanical fasteners (e.g. screws, bolts, welding, magnetic fasteners, etc.), adhesives (glue, etc.), chemical bonding, or other suitable means for securing the individual modules together to form the tank assembly 14. In some aspects, for example as shown in FIGS. 4-5, the tank modules 16 also define or form the frame 12 of the apparatus and a separate frame may not be included. In still yet other examples, the frame 12 may be positioned internally to the tank assembly 14.

By utilizing tank modules 16 which provide for a modular assembly of the closed loop tank assembly 14, only a limited number of tank modules 16 may be needed to manufacture while providing for ease of assembly of different sized and shaped closed loop tank assemblies 14. In other words, a standard set of tank modules 16 may be manufactured which may then be arranged in varying combinations to arrive at a closed loop tank assembly 14 having the desired size and shape. The modular nature of the closed loop tank assembly 14 also provides for ease of assembly and disassembly.

Though in the non-limiting example depicted in FIG. 2 the apparatus includes four curved tank modules 16 and two straight tank modules 16 to define the closed loop tank assembly 14, in other embodiments different numbers and combinations of tank modules 16 may be used to form different sized and shaped closed loop tank assemblies 14. In some aspects of the present disclosure the closed loop tank assembly 14 may comprise a single tank module 16, as opposed to multiple modules 16 coupled together.

A fluid, such as water, may be positioned within the closed loop tank assembly 14. A propulsion device (not visible in FIG. 2 as it is positioned on the interior of the closed loop tank assembly 14), such as one or more propellers or impellers may be positioned within the closed loop tank assembly 14 for controlling circulation of the fluid in a desired direction. The propulsion device may be controlled by a power source, such as a battery unit or other electrical components. A component housing 18 may be positioned internally, externally, or in any other suitable position relative to the closed loop tank assembly 14. In FIG. 2, a component housing 18 is positioned within an inner region defined by the size and shape of the closed loop tank assembly 14 and may receive one or more electrical components of the apparatus 10. Additional component housings 18 may be positioned elsewhere as depicted in FIG. 2. The component housing 18 may house a power source 20 for providing power to one or more electrical components of the apparatus 10. The power source 20 may include but is not limited to a battery unit. For example, the power source 20 may provide power to one or more propulsion devices of the apparatus 10. The component housing 18 may also house additional elements of the apparatus 10, for example but not limited to a control system or unit (or controller) 22 that controls the direction and speed the one or more propulsion devices (e.g. propellers or impellers), or otherwise controls the propulsion device(s) to thereby control the speed and direction of the fluid in the closed loop tank assembly 14. For example, an impeller can control the direction and speed of the water circulating within the closed loop tank assembly 14. The control unit 22 can receive instructions wirelessly from another device, for example a control system or unit (or controller) separate from the apparatus 10 (for example controller 8 depicted in FIG. 1). In some aspects, the control unit 22 can receive wireless instructions from a mobile phone which may include software designed for controlling one or more elements of the apparatus 10 (e.g., the propeller or the impeller or the guide features) as described herein. Though in other aspects the control system in communication with one or more control units (e.g. control unit 22) of the apparatus 10 may be located within the lifting machinery (e.g. the crane). The direction and speed of the fluid circulating within the closed loop tank assembly 14 can impart a rotational force on the load coupling and orientation control apparatus 10, and thereby impart a force on a load coupled to the apparatus relative to the earth or ground, for example as described in U.S. U.S. Pat. No. 10,207,903. FIG. 2 depicts the component housing 18 as being secured in place relative to the frame 12 via one or more rigid members 24, though other suitable means may be used for securing the component housing 18 in place relative to the frame 12.

The apparatus 10, may thereby control the position of the load when lifted, for example to maintain a position of the load (e.g. stop it from spinning), or to orient the load in a desired position (e.g. position a first end of the load in a desired position or orientation), the apparatus 10 may further control the position or orientation of the load when the load is lowered to provide for improved placement of the load in its desired lowered location. For example, a load comprising a shipping container may be oriented by the apparatus 10 when in a lifted position and subsequently lowered such that the shipping container is in a desired position relative to a location the shipping container is being placed (e.g. on a ship, a dock, a truck, or the like) to provide for improved ease of placement and accuracy of placement of the load. In other words, the orientation of the load may be controlled during lifting and lowering of the load to aid in security, safety, and accuracy of placement at the work site. By controlling the position of the load remotely, workers on the ground may have reduced chance of injury. In addition, by controlling the position of the load during lowering, the load may be positioned in its desired placement faster, easier, with improved accuracy, and with less risk to the workers at the work site (e.g. on a truck, in a wellbore, on a ship, on a dock, etc.).

Though FIG. 2 depicts the component housing 18 as holding both the power source 20 and control unit 22 internal relative to the tank assembly 14, in some aspects, one or more of the power source 20, control until 22, and/or other electrical components may be positioned together or separately within one or more housings that are positioned in any suitable position relative to the frame 12 and the closed loop tank assembly 14. In some embodiments of the present disclosure the power source 20 (e.g. battery unit) or other electrical components may be positioned elsewhere relative to the frame 12, for example within regions extending between the closed loop tank assembly 14 and the frame 12. In still yet other embodiments, the power source 20 (e.g. battery unit) or electrical components may be positioned within a space defined by one or more frame members 12′.

In some aspects, the apparatus 10 may include one or more solenoids for controlling movement of one or more features of the apparatus. For example, one or more solenoids may control the position of the guide features 32. In some embodiments, a single solenoid may control the actuation of one or more of the guide features 32 between the actuated and stored positions. In some aspects, one or more of the guide features 32 of the apparatus 10 may be independently operated. One or more solenoids may be used to actuate one or more of the locking systems 50 of the apparatus 10. The one or more solenoids that control one or more locking systems 50 may be positioned within one or more of the component housings 18. One or more transceivers for receiving instructions to actuate one or more guide features 32 may also be positioned within one or more of the component housings 18. Similarly, one or more transceivers for receiving instructions to actuate the locking systems 50 may be positioned within one or more of the component housings 18. In some aspects, a single transceiver may receive instructions related to each of the guide features 32 and each of the locking systems 50. One or more control units 22 (or controllers) may be positioned within one or more of the component housings 18 and may control one or more of the guide features 32 and/or one or more of the locking systems 50 in response to the communication(s)/signal(s) received by one or more transceivers. For example a control system or unit (or controller) separate from the apparatus 10 (for example controller 8 depicted in FIG. 1) may be in wireless communication with one or more control units 22 for controlling the one or more guide features 32 and/or one or more of the locking systems 50. Though in other aspects the control system in communication with one or more control units (e.g. control unit 22) of the apparatus 10 may be located within the lifting machinery (e.g. the crane).

The load coupling and orientation control apparatus 10 may be a remote load coupling and orientation control apparatus 10 that may be coupled to a load via a remote engagement between the load and the apparatus. In some aspects, the apparatus 10 may include one or more locking point or system 50 for remote coupling between the apparatus 10 and a load (e.g. an ISO shipping container or other load) as described in USPN 11,358,838, entitled “System and Method for Controlling the Lifting and Handling of a Load”, filed on Sep. 24, 2020, the entire contents of which is incorporated herein by reference.

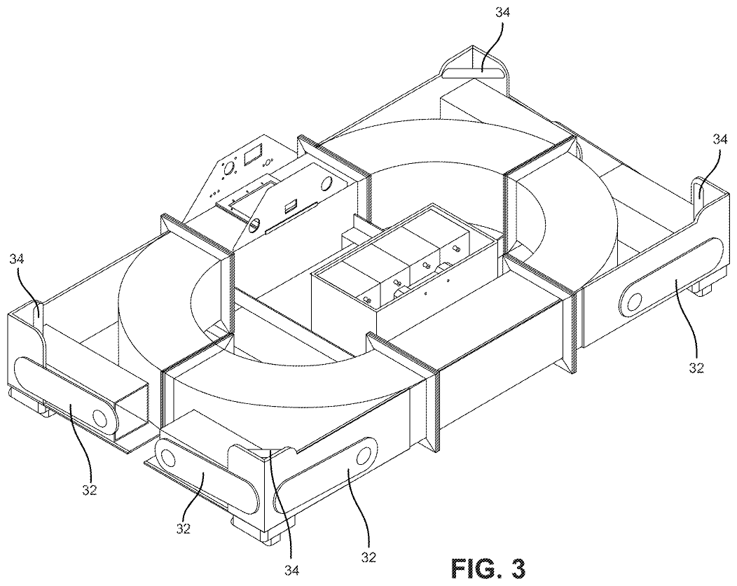

In some aspects, the apparatus 10 may include guide features 32, for example but not limited to guide paddles as shown in FIGS. 2-3, for aiding in positioning the apparatus 10 relative to the load when coupling the apparatus 10 to the load. In some aspects, as shown in FIGS. 2-3, the guide features 32 may be guide paddles that are rotatable between a deployed position (depicted in FIG. 2) and a storage position (depicted in FIG. 3). In the deployed position, as shown in FIG. 2, the guide features 32 may be projecting away from the apparatus 10 for aiding in aligning the apparatus 10 with a load, for example but not limited to an ISO shipping container. In the storage position, as shown in FIG. 3, the guide features 32 may be rotated relative to the frame 12 of the apparatus 10 such that they do not extend substantially beyond the frame 12 of the apparatus 10. The guide features 32 may be remotely moveable between the deployed position and the storage position, for example via a wireless connection that receives instructions for positioning the guide features 32 from a remote device or control system or unit (or controller), for example but not limited to controller 22 or a separate controller. The guide features 32 may be powered via individual power sources or a single power source, for example power source 20. The guide features 32 may help align the apparatus with the container by aiding in aligning the frame 12 of the apparatus 10 with the outer edges of the top of the load (e.g. a shipping container). FIG. 3 depicts the apparatus 10 of FIG. 2 with the guide features 32 in a non-limiting exemplary stored position.

The remote load coupling and orientation control apparatus 10 according to aspects of the present disclosure may also include one or more lifting features 34 as shown in FIGS. 2-3. The lifting features 34 may aid in coupling the frame 12 to a hook or other coupling feature, for coupling to a crane or other lifting machinery. Though shown in the non-limiting example of the apparatus 10 in FIGS. 2-3 as bars positioned in the corners of the frame 12, in other contemplated aspects of the present disclosure the lifting features 34 may be shaped or positioned elsewhere on the frame 12. For example, the lifting features 34 may include hooks, loops, or other features positioned in various location relative to the apparatus 10 for coupling the apparatus 10 to the lifting machinery. The apparatus 10 may be coupled to a crane or other lifting machinery manually using ground workers prior to the apparatus 10 being coupled to the load. In still yet other embodiments, mating features on the apparatus 10 may couple to the lifting machinery such that the apparatus 10 may be coupled to the lifting machinery in a remote manner without the use of manual connection put in place by one or more ground workers.

Though some aspects of the present disclosure include both a closed loop tank assembly 14 and a separate frame 12, in some aspects, the closed loop tank assembly 14 may also define the frame 12 of the apparatus 10. In other words, in some aspects, the lifting frame 12 is formed by the tank modules 16 and or integral with the tank modules 16, such that the closed loop tank assembly 14 is the frame 12. This can reduce the overall weight of the apparatus 10. In such aspects, the lifting features 34, electronics (e.g. power source 20, control unit 22), and/or other elements/features of the apparatus 10 may be coupled to the closed loop tank assembly 14 defining the frame 12, without a separate frame 12. In other words, in some aspects, features or frame members 12′ defining the frame 12 such that no separate frame 12 is used. While in some aspects, a separate frame 12 may be secured to the closed loop tank assembly 14, or in some aspects integral with the closed loop tank assembly. For example, in some aspects, the tank modules 16 of the closed loop tank assembly 14 may include support members or other features for coupling to various elements of the apparatus 10 (e.g. lifting features 34, component housing 18, guide features 32, etc.). In still yet some aspects, the closed loop tank modules 16 as depicted in various examples herein may be used as the frame 12, with no additional support members or frame assembly coupled, secured to, or integral with the modules 16, such that the lifting features 34, component housing 18, guide features 32, and/or other elements of the apparatus 10 are coupled to the modules 16.

FIG. 4 depicts a non-limiting exemplary embodiment of a load coupling and orientation control apparatus 40 where the closed loop tank assembly 42 itself defines a frame of the apparatus 40. In such aspects, the total weight of the apparatus 40 may be reduced by having the closed loop tank assembly 42 also define the frame. The apparatus 40 may include one or more lifting connections 44, show in FIG. 4 as four loops, secured to the assembly 42 to aid in coupling the apparatus 40 to a crane or other lifting machinery. Though shown in the non- limiting example of the apparatus 40 in FIG. 4 as loops, the present disclosure contemplates the lifting connections 44 being shaped as bars, hooks, loops, or any other suitable features that may be positioned in any suitable locations of the apparatus 40. FIG. 5 depicts a perspective view of the apparatus 40 coupled to a load via load 3 coupling features 46 on an underside of the apparatus 40. The closed loop tank assembly 42 may receive a fluid 45 and the assembly 42 may further include a propulsion device 48. The propulsion device 48 may be an impeller, a propellor, or other suitable propulsion device for controlling the circulation of the fluid in a desired direction at a desired speed. The propulsion device may be controlled by a battery unit or other electrical component, for example as depicted in the aspect shown in FIGS. 2-3. The battery unit or other electrical component may also include a control unit that controls the direction and speed the propulsion device rotates in the tank assembly 42, similar to as described above with respect to FIGS. 2-3. The same or different propulsion device 48 may be utilized in one or more embodiments of the present disclosure, for example but not limited to the apparatus 10 described with respect to FIGS. 2, 3, and 6.

As described above with respect to the apparatus 10, the apparatus 40 may thereby control the position of the load when lifted, for example to maintain a position of the load 3 (e.g. stop it from spinning), or to orient the load in a desired position (e.g. position a first end of the load in a desired position or orientation), the apparatus 40 may further control the position or orientation of the load 3 when the load 3 is lowered to provide for improved placement of the load in its desired lowered location. For example, a load 3 comprising a shipping container may be oriented by the apparatus 40 when in a lifted position and subsequently lowered such that the shipping container is in a desired position relative to a location the shipping container is being placed (e.g. on a ship, a dock, a truck, or the like) to provide for improved ease of placement and accuracy of placement of the load 3. In other words, the orientation of the load may be controlled during lifting and lowering of the load 3 to aid in security, safety, and accuracy of placement at the work site. By controlling the position of the load 3 remotely, workers on the ground may have reduced chance of injury. In addition, by controlling the position of the load 3 during lowering, the load may be positioned in its desired placement faster, easier, with improved accuracy, and with less risk to the workers at the work site (e.g. on a truck, in a wellbore, on a ship, on a dock, etc.).

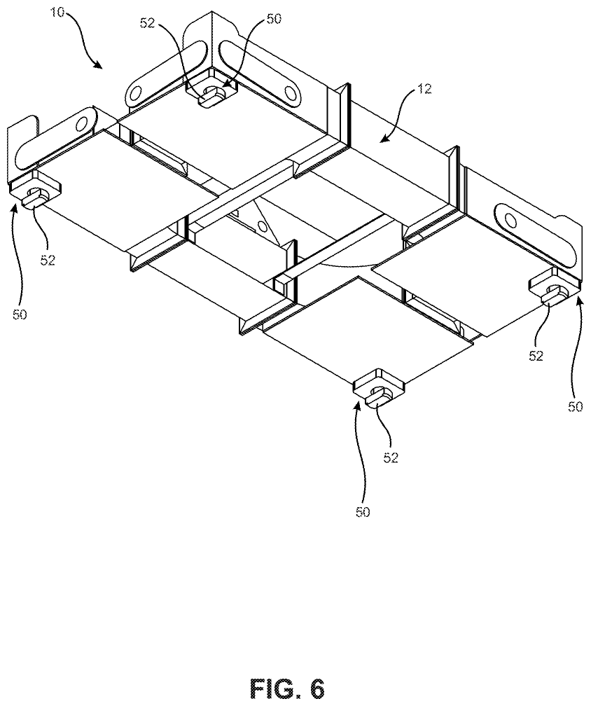

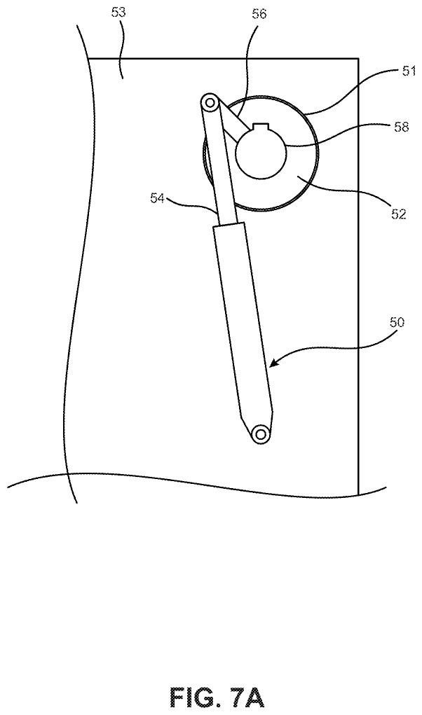

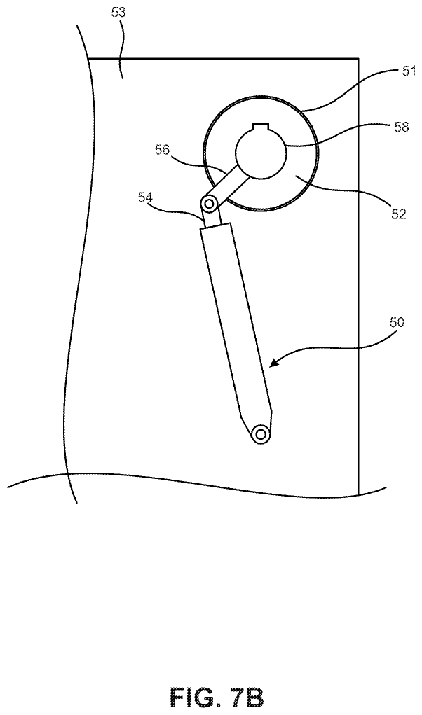

In aspects of the present disclosure, it is contemplated that a load coupling and orientation control apparatus may also include a plurality of locking points or systems for coupling the apparatus to a load, for example locking system 50 depicted in FIGS. 2-3, and 5. FIG. 6 depicts a bottom perspective view of the apparatus 10 depicting a plurality of locking systems 50 which may each include a locking body 52 that protrudes from an underside of the frame 12. In other aspects, the locking systems 50 may extend from different locations long the underside or side regions of the apparatus 10. The locking bodies 52 may be sized and shaped to be received in a chamber of an ISO shipping container for securing the apparatus 10 to the shipping container. For example, each locking body 52 may be sized and shaped to be positioned within a chamber at a corner of an ISO shipping container and may be movable between a locked position and an unlocked position. The locking body 52 may rotate from the unlocked position to the locked position when it is positioned within the chamber for locking or engaging within the chamber for securing the apparatus 10 to the shipping container prior to lifting. FIGS. 7A-7B depicts a non-limiting exemplary schematic diagram of a locking system 50. The locking system 50 may include the locking body 52, an actuator 54, a lever 56, and a gear 58. In some aspects, the apparatus 40 may include one or more solenoids for controlling movement of one or more features of the apparatus.

FIG. 7A depicts a schematic diagram of the locking system 50 in an unsecured position within an opening 51 of a load (or container) 53 (e.g. an ISO Shipping Container), in the unsecured position the actuator 54 may be in a first position (e.g. an extended position, though in some aspects it may be a retracted position as shown in FIG. 7B). FIG. 7B depicts a schematic diagram of the locking system 50 in a secured position, in the secured position the actuator 54 may be in a second position (e.g. a retracted position, though in some aspects it may be an extended position as shown in FIG. 7A). In FIGS. 7A-7B various elements of the locking system 50 are depicted which in many aspects, such as those aspects shown in FIGS. 2-3, and 5 would not be visible, they are depicted in these figures for clarity purposes.

The locking body 52 can be sized and shaped to fit within the opening 51 in the load 53, for example within a standard ISO cast chamber in a corner (or other suitable location) of a shipping container. For example, the opening 51 in the container 53 may be a chamber that is generally oblong in shape and into which the locking body can extend. The locking body 52 can be sized and shaped to permit the locking body 52 to be positioned at least partially in the chamber of the container 53. The locking body 52 can be sized and shaped such that when in an unsecured position, it may be positioned within the chamber, the locking body 52 may then be rotated from the unsecured position to the secured position such that it becomes securely engaged with or locked within the chamber. For example, without limitation, the locking body 52 may have a shape that is oblong, generally oblong, generally rectangular, or otherwise suitable shaped to engage with the sides/walls/surfaces of the chamber of the container 53 such that the locking body 52 may be secured within the chamber and may not be retracted from the chamber when in this secured position.

The actuator 54 of the locking system 50 may control the position or rotation of the locking body 52. The actuator 54 may be controlled remotely in some embodiments. The actuator 54 may be a piston, for example, that may extend or retract in length. The actuator 54 may be coupled to the lever 56 that may in turn be coupled to the locking body 52 for controlling the position of the locking body (e.g. rotating the locking body between the unsecured and secured positions) in response to the movement of the actuator 54. The lever 56 may be coupled to the locking body 52 via the gear 58. The actuator 54 may move between the first position that corresponds to the locking body 52 (and thereby the locking system 50) being in the unlocked position in which it may be positioned within the chamber of the container, to the second position which corresponds to the locking body 52 (and thereby the locking system 50) being in the secured position in which it is locked or secured within the chamber of the container. The length of the actuator 54, the lever 56, and the position of the gear 58 relative to the actuator 54 and lever 56 may be selected to correspond with the size, orientation, and location of the chamber relative to the boundaries of the container such that the elements of the locking system 50 do not extend beyond the edges of the container.

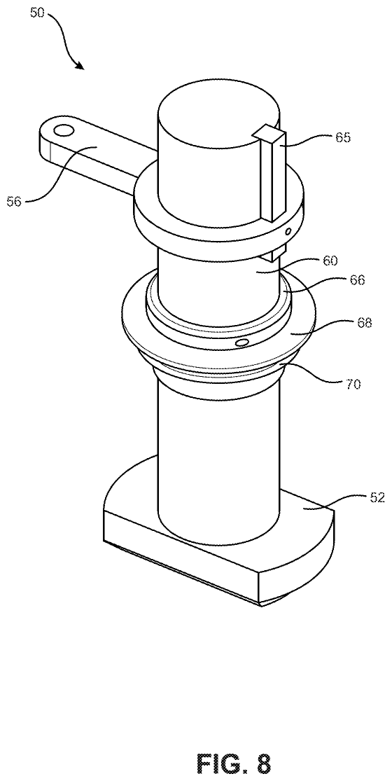

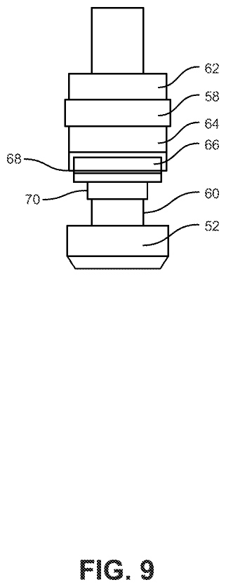

FIG. 8 depicts an elevation view of the locking system 50 in an unsecured position according to some aspects of the present disclosure. The locking system 50 may further include additional elements, including for example, a shaft 60, a nut 62 (shown in FIG. 9), a spacer 64 (shown in FIG. 9), a split collet and retainer 66, a thrust washer 68, a bearing bush 70, and a key 71 (shown in FIG. 9). The locking system 50 may also include a key 71. However, more or fewer elements may be used without departing from the scope of the present disclosure. A load coupling and orientation control apparatus in accordance with the present disclosure may include one or more locking systems 50. The locking systems 50 may each be independently operated/controlled or may be variably actuated independent of one another. In some aspects, each locking system 50 may include a control system or unit (or controller), such as controller 22 or another controller) that may be in wired or wireless communication with a device (e.g. control system 8 or other control system) for controlling the actuation of the locking system 50. Though depicted with respect to the apparatus 10 of FIGS. 2-3, locking systems 50 may be utilized with the apparatus 40 depicted in FIGS. 4-5 or in still yet other aspects of the present disclosure.

FIG. 9 depicts a perspective schematic diagram of a portion of the locking system 50 including the locking body 52, the shaft 60, the lever 56, the split collet 66, the thrust washer 68, the bearing bush 70, and the key 71. In other words, FIG. 9 depicts the locking system 50 without the actuator 54 coupled to the lever 56. As shown in FIG. 9, the key 71 may be sized and shaped to retain the lever 56 in position on the shaft 60. The split collet 66 may sit in a groove on the shaft 60, and the thrust washer 68 may be positioned between the split collet 66 and the bearing bush 70. The actuator (not shown in FIG. 9), and thereby the lever 56, may be controlled by a wireless remote control.

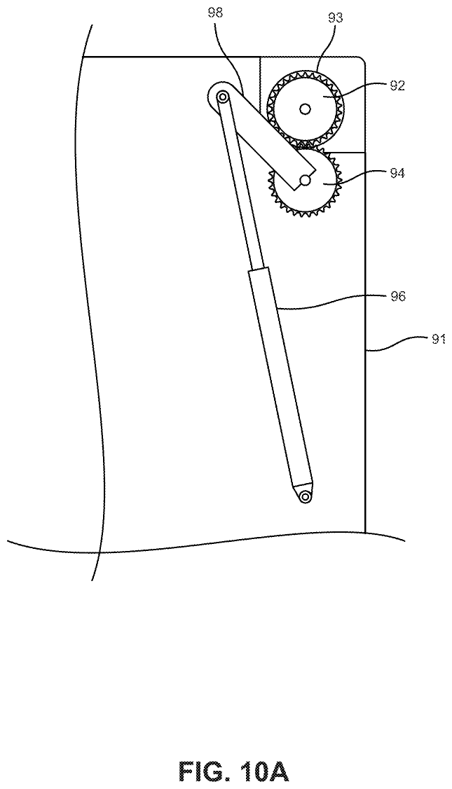

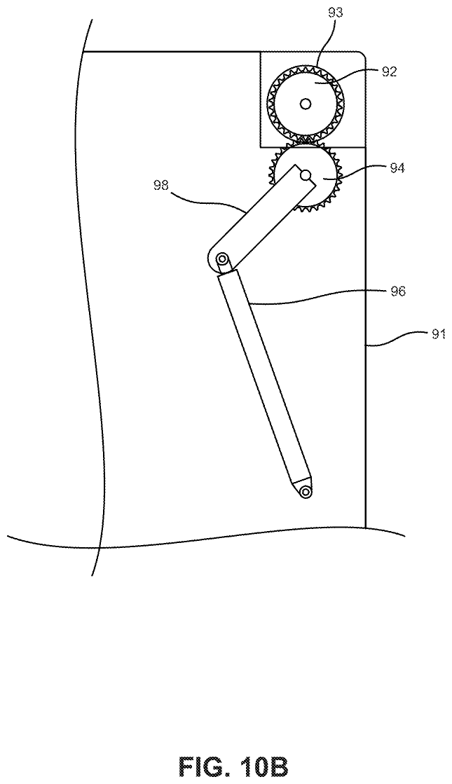

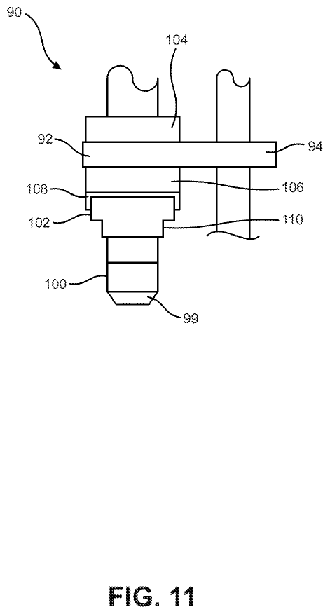

In still yet another aspect of the present disclosure, a load coupling and orientation control apparatus may include a locking system 90, as depicted in FIGS. 10A, 10B, and 11. FIGS. 10A-10B depicts a schematic view of the locking system 90 that includes a first gear 92, a second gear 94, an actuator 96, a lever 98, and a locking body 99 (not shown in FIGS. 10A-10B). In FIG. 10A, depicting a schematic diagram of the locking system 90 engaged with an opening 93 in a corner of a shipping container 91, the locking system 90 in an unsecured position, in the unsecured position the actuator 96 may be in a first position (e.g. an extended position, though in other aspects it may be a retracted position for example as shown in FIG. 10B). FIG. 10B depicts the locking system 90 in the schematic diagram positioned within an opening in the corner of the shipping container 91 in a secured position, in the secured position the actuator 96 may be in a second position (e.g. a retracted position, though in other aspects it may be an extended position as shown in FIG. 10A). Though in normal functioning the first gear 92 may not be visible, it is provided in FIGS. 10A-10B for clarity purposes. Similarly, the locking body 99 is not depicted in FIGS. 10A-10B for clarity in depicting other features of the locking system 90. FIG. 11 depicts an end elevation view of the locking system 90 in an unlocked or unsecured position in which the locking body 99 may be inserted into or removed from the chamber of the container/load. As shown in FIG. 11, the locking system 90 may also include a shaft 100, a thrust washer 102, the first gear 92, a nut 104, the second gear 94, a spacer 106, a split collet and retainer 108, and a bearing bush 110. The locking system 90 may be used in place of the locking system 50 as depicted in FIGS. 2, 3 6, or in place of the load coupling features 46 in FIG. 5. In FIGS. 10A-10B various elements of the locking system 50 are depicted which in many aspects, such as those aspects shown in FIGS. 2-3, and 5 would not be visible, they are depicted in these figures for clarity purposes. In some aspects of the present disclosure the locking system utilized with a remote load coupling and control apparatus according to aspects of the present disclosure may be a locking system disclosed in U.S. patent application Ser. No. 18/537,660, filed Dec. 12, 2023.

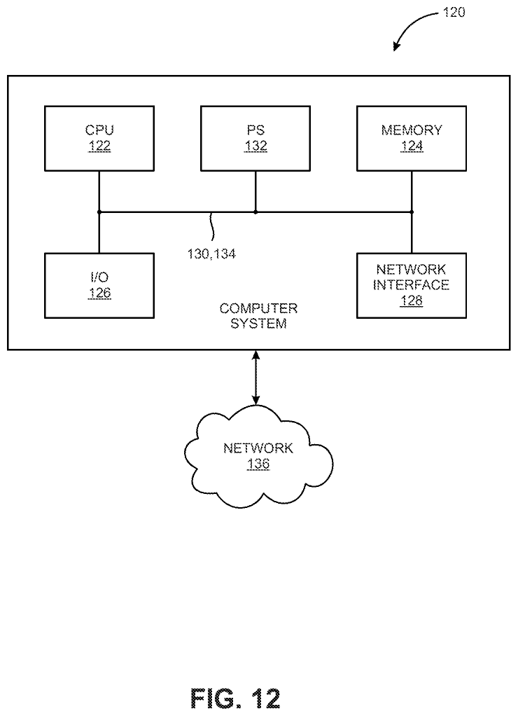

Referring to FIG. 12, one embodiment of a computer system 120 is illustrated. The computer system 120 is one possible example of a system component or device such as the control system or unit (or controller) 22 or a separate system or unit (or controller) used to perform the various processes described herein, for example but not limited to systems related to the locking systems, guide features, and/or propulsion device disclosed herein. In scenarios where the computer system 120 is on-site, such as within the work site 1 of FIG. 1, the computer system may be contained in a relatively rugged, shock resistant case that is hardened for industrial applications and harsh environments. In addition, the computer system 120 is one possible example of a system or component or device used to send information to or receive information from a remote load coupling and orientation apparatus according to aspects of the present disclosure, for example but not limited to controller 8 which may be a wired or wireless controller. In other words, the computer system 120 is a non-limiting example of a possible system, including but not limited to the controller 8 in FIG. 1, from which a worker may remotely control one or more features of a remote load coupling and orientation apparatus according to aspects of the present disclosure.

The computer system 120 may include a central processing unit (“CPU”) 122, a memory unit 124, an input/output (“I/O”) device 126, and a network interface 128. The components 122, 124, 126, and 128 are interconnected by a transport system (e.g., a bus) 130. A power supply (PS) 132 may provide power to components of the computer system 120 via a power transport system 134 (shown with data transport system 130, although the power and data transport systems may be separate).

It is understood that the computer system 120 may be differently configured and that each of the listed components may actually represent several different components. For example, the CPU 182 may actually represent a multi-processor or a distributed processing system; the memory unit 124 may include different levels of cache memory, main memory, hard disks, and remote storage locations; the I/O device 126 may include monitors, keyboards, and the like; and the network interface 188 may include one or more network cards providing one or more wired and/or wireless connections to a network 136. Therefore, a wide range of flexibility is anticipated in the configuration of the computer system 120.

The computer system 120 may use any operating system (or multiple operating systems), including various version of operating systems provided by Microsoft (such as WINDOWS), Apple (such as Mac OS X), UNIX, and LINUX, and may include operating systems specifically developed for handheld devices, personal computers, mobile devices, and servers depending on the use of the computer system 120. The operating system, as well as other instructions (e.g., software instructions for performing the functionality described in various embodiments described herein) may be stored in the memory unit 124 and executed by the processor 122. For example, the memory unit 124 may include instructions for performing the various methods and control functions disclosed herein.

The network 136 may be a single network or may represent multiple networks, including networks of different types. For example, the network 136 may include one or more cellular links, data packet networks such as the Internet, local area networks (LANs), and/or wide local area networks (WLAN), and/or Public Switched Telephone Networks (PSTNs). Accordingly, many different network types and configurations may be used to couple the computer system 120 to other components of the worksite 1, for example but not limited to elements of the load coupling and orientation apparatus 10, 40 or other elements described here, and/or to other systems not shown (e.g., remote systems).

In some aspects, as described above with respect to the apparatus 10 (or 40) one or more solenoids may be used to actuate one or more of the locking systems 90 of an apparatus according to aspects of the present disclosure. The one or more solenoids that control one or more locking systems 90 may be positioned within one or more of the component housings of the apparatus. One or more transceivers for receiving instructions to actuate the locking systems 90 may be positioned within one or more of the component housings of the apparatus. In some aspects, a single transceiver may receive instructions related to each of the locking systems 90. One or more control units 22 (or controllers) may be positioned within one or more of the component housings 18 and may control one or more of the locking systems 90 in response to the communication(s)/signal(s) received by one or more transceivers.

According to all aspects of the present disclosure, limit switches may be included in a load coupling and orientation control apparatus (e.g. as part of one or more locking systems 50, 90) to detect and report the position of the locking system (e.g. locked/secured vs. unlocked/unsecured back to another device (e.g. a handset). Moreover, one or more elements of a remote load coupling and orientation control apparatus, including but not limited, to apparatus 10, may be controlled remotely via a remote device (e.g. the handset). For example, the locking system(s), guide feature(s), impeller(s), or propeller(s), and/or other elements may be controlled remotely, including via a limit switch though other suitable control means may be used. For example, and without limitation, the locking system 50, 90 (e.g. the locking body 52, 99 of said systems 50, 90) of the apparatus may be locked/unlocked relative to the load to be lifted via a remote device and the status (or position) of the locking system (e.g. locked vs. unlocked) may be provided to the remote device. For example, in some aspects a device may receive a signal from the apparatus that causes an indicator on a remote device (e.g. a mobile phone, a handheld device, etc.) that may indicate the remote load coupling and orientation control apparatus is in a particular orientation (e.g. locked/unlocked) relative to the load (i.e. unsecured). For example, the indicator can correspond to a light being illuminated (e.g. a red light may indicate the locking system is in an unsecured position and/or a green light may indicate the locking system is in a secured position). In some aspects, the indicator may be a sound, a message (e.g. a text message, e-mail, or similar message), or other visual or auditory indicator, may be transmitted to a remote device for indicating the status or position of one or more locking systems of a remote load coupling and orientation control apparatus. Thus, one or more elements of a remote load coupling and orientation control apparatus 10, 40 may be controlled wireless via a device and an indication related to the status/position of one or more elements of the apparatus may be transmitted wirelessly to a device.

Furthermore, relative terms such as, “lower”, “upper”, “up”, “down”, “above”, “below,” “downward,” “upward” and the like are used herein to indicate directions and locations as they apply to the appended drawings and will not be construed as limiting the invention and features thereof to particular arrangements or orientations.

Non limiting Examples of aspects of the present disclosure are further provided.

Example 1 provides a remote load coupling and orientation control apparatus comprising a closed loop tank assembly comprising a plurality of tank modules, wherein a fluid is positioned within the tank modules of the closed loop tank assembly; a propulsion device for controlling a direction and a speed of the fluid positioned within the closed loop tank assembly; a plurality of locking systems for coupling the remote load coupling and orientation control apparatus to a load; a power source for powering the propulsion device; and a controller for controlling a position of the plurality of locking systems.

Example 2 provides a remote load coupling and orientation control apparatus of claim 1, further comprising a plurality of guide features movable between a storage position and a deployed position, wherein the guide features are configured to aid in positioning the remote load coupling and orientation control apparatus for remote coupling to the load via the plurality of locking systems.

Example 3 provides a remote load coupling and orientation control apparatus of any of Examples 1-2, further comprising a connection housing, wherein the controller for controlling the position of the plurality of locking systems is positioned within the connection housing.

Example 4 provides a remote load coupling and orientation control apparatus of any of Examples 1-3, wherein the controller is also communicatively coupled to the propulsion device for controlling the propulsion device.

Example 5 provides a remote load coupling and orientation control apparatus of any of Examples 1-4, further comprising another controller that is communicatively coupled to the propulsion device for controlling the propulsion device.

Example 6 provides a remote load coupling and orientation control apparatus of any of Examples 1-5, wherein each locking systems of the plurality of locking system further comprises: a locking body; an actuator; a lever; and a gear, wherein, the lever is coupled between the actuator and the gear such that the lever rotates in response to the actuation of the actuator, wherein the gear is coupled between the locking body and the lever such that the locking body moves in response to the rotation of the lever, and wherein the locking body is movable between a first position and a second position in response to the actuation of the actuator.

Example 7 provides a remote load coupling and orientation control apparatus of Example 6, wherein the actuator is positioned within a connection housing.

Example 8 provides a remote load coupling and orientation control apparatus of any of Examples 1-7, wherein the power source is a battery

Example 9 provides for a remote load coupling and orientation control apparatus of any of Examples 1-8 wherein and propulsion device is an impeller.

Example 10 provides a remote load coupling and orientation control apparatus of any of Examples 1-9, wherein the closed loop tank assembly comprises at least one generally curved tank module and at least one generally rectangular tank module.

Example 11 provides a remote load coupling and orientation control apparatus of any of Examples 1-10, further comprising a power source for powering the propulsion device and a frame member coupled to the closed loop tank assembly.

Example 12 provides a remote load coupling and orientation control apparatus of any of Examples 1-11, further comprising a frame member coupled to the closed loop tank assembly.

Example 13 provides a remote load coupling and orientation control apparatus of any of Examples 1-12 wherein the closed loop tank assembly defies a frame member.

Example 14 provides a remote load coupling and orientation control apparatus of any of Examples 1-13 further comprising a transmitter for transmitting a wireless signal to a device, wherein the wireless signal corresponds to a position of an element of the remote load coupling and orientation control apparatus.

Example 15 provides a remote load coupling and orientation control apparatus of any of Examples 1-14, further comprising a receiver for receiving a wireless signal from a device, wherein the wireless signal corresponds to instructions for operation of the remote load coupling and orientation control apparatus.

Example 16 provides a method of connecting a remote load coupling and orientation control apparatus to a load, comprising providing a remote load coupling and orientation control apparatus. The remote load coupling and orientation control apparatus further includes a closed loop tank assembly comprising a plurality of tank modules, wherein a fluid is positioned within the closed loop tank assembly; a propulsion device for controlling a direction and a speed of the fluid positioned within the closed loop tank assembly; a power source for powering the propulsion device; a plurality of locking systems for coupling the remote load coupling and orientation control apparatus to a load. The method may further include positioning the remote load coupling and orientation control apparatus such that each locking system is positioned within a chamber of the load; actuating each lifting connection from an unsecured position to a secured position within the chamber; lifting the load by lifting the remote load coupling and orientation control apparatus when each locking system is in the secured position such that the remote load coupling and orientation control apparatus is coupled to the load; and activating the propulsion device for controlling the orientation of the lifted load.

Example 17 provides a method of Example 16, wherein the propulsion device is an impeller or a propeller.

Example 18 provides a method of any of Examples 16-17, wherein the remote load coupling and orientation control apparatus further comprises a frame member coupled to the closed loop tank assembly .

Example 19 provides a method of any of Examples 16-18, wherein the step of actuating the propulsion device for controlling the orientation of the lifted load further comprises receiving, by a transceiver, a signal from a remote device corresponding to an instruction to rotate the propulsion device in a desired direction at a desired rate; and sending, by a controller, a signal to the propulsion device to rotate in the desired direction at the desired rate.

Example 20 provides a method of any of Examples 16-19, further comprising the steps of detecting the position of the locking systems and transmitting a wireless signal to a remote device, the wireless signal corresponding to the position of the lifting connection, and the step of displaying an indication on the remote device corresponding to the position of the lifting connection.

Example 21 provides a method of any of Examples 16-20, wherein the step of actuating the propulsion device for controlling the orientation of the lifted load further comprises actuating the propulsion device for positioning the lifted load in a desired position relative to a lowering location; and lowering the lifted load in the desired position onto the lowering location.

Example 22 provides for a method of any of Examples 16-21, wherein the desired position of the lifted load is defined relative to the size and shape of the lowering location.

Example 23 provides for a method of any of Examples 16-20, wherein the step of actuating the propulsion device for controlling the orientation of the lifted load further comprises actuating the propulsion device for maintaining a desired orientation of the lifted load relative to a lowering location; and lowering the lifted load in the desired orientation onto the lowering location.

Example 24 provides for a method of any of Examples 16-20, wherein the remote device is a mobile telephone, a handheld device, or a computing device.

Example 25 provides for a method of any of Examples 16-24, wherein the propulsion device comprises a propeller, an impeller, a plurality of propellers, a plurality of impellers, or a combination of one or more propellors and one or more impellers.

Example 26 provides for a load coupling and orientation control apparatus comprising:

a closed loop tank assembly, wherein a fluid is positioned within the closed loop tank assembly; a propulsion device for controlling a direction and a speed of the fluid positioned within the closed loop tank assembly to thereby control orientation of the closed loop tank assembly; and a plurality of locking systems for coupling the load coupling and orientation control apparatus to a load.

Example 27 provides for a load coupling and orientation control apparatus of Example 26, further comprising a controller coupled to the propulsion device and adapted to receive and send wireless signals to a remote control device.

Example 28 provides for a load coupling and orientation control apparatus of any of Examples 26-27, wherein the closed loop tank assembly comprises a plurality of tank modules connected to one another.

Example 29 provides for a load coupling and orientation control apparatus of any of Examples 26-28 wherein the closed loop tank assembly has a generally rounded rectangular shape, a generally circular shape, or a generally elliptical shape.

Example 30 provides for a load coupling and orientation control apparatus of any of Examples 26-29, wherein the propulsion device comprises a propeller, an impeller, a plurality of propellers, a plurality of impellers, or a combination of one or more propellers and one or more impellers.

Example 31 provides for a load coupling and orientation control apparatus of any of Examples 26-30, wherein the load coupling and orientation control apparatus is adapted to move in a counterclockwise direction in response to movement of the fluid in a clockwise direction.

Example 32 provides for a load coupling and orientation control apparatus of any of Examples 26-31, wherein the load coupling and orientation control apparatus is adapted to move in a clockwise direction in response to movement of the fluid in a counterclockwise direction.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilize the invention in various embodiments and with various modifications as are suited to the particular use contemplated. Therefore, further modifications or improvements may be incorporated without departing from the scope of the invention herein intended.

1. A remote load coupling and orientation control apparatus comprising:
a closed loop tank assembly comprising a plurality of tank modules, wherein a fluid is positioned within the tank modules of the closed loop tank assembly;
a propulsion device for controlling a direction and a speed of the fluid positioned within the closed loop tank assembly;
a plurality of locking systems for coupling the remote load coupling and orientation control apparatus to a load;
a power source for powering the propulsion device; and
a controller for controlling a position of the plurality of locking systems.

2. The remote load coupling and orientation control apparatus of claim 1, further comprising:
a plurality of guide features movable between a storage position and a deployed position, wherein the guide features are configured to aid in positioning the remote load coupling and orientation control apparatus for remote coupling to the load via the plurality of locking systems.

3. The remote load coupling and orientation control apparatus of claim 1, further comprising a connection housing, wherein the controller for controlling the position of the plurality of locking systems is positioned within the connection housing.

4. The remote load coupling and orientation control apparatus of claim 1, wherein the controller is also communicatively coupled to the propulsion device for controlling the propulsion device.

5. The remote load coupling and orientation control apparatus of claim 1, further comprising another controller that is communicatively coupled to the propulsion device for controlling the propulsion device.

6. The remote load coupling and orientation control apparatus of claim 1, wherein each locking systems of the plurality of locking system further comprises:
a locking body;
an actuator;
a lever; and
a gear,
wherein, the lever is coupled between the actuator and the gear such that the lever rotates in response to the actuation of the actuator,
wherein the gear is coupled between the locking body and the lever such that the locking body moves in response to the rotation of the lever, and
wherein the locking body is movable between a first position and a second position in response to the actuation of the actuator.

7. The remote load coupling and orientation control apparatus of claim 6, wherein the actuator is positioned within a connection housing.

8. The remote load coupling and orientation control apparatus of claim 1, wherein the power source is a battery.

9. The remote load coupling and orientation control apparatus of claim 1, wherein the propulsion device is an impeller.

10. The remote load coupling and orientation control apparatus of claim 1, wherein the closed loop tank assembly comprises at least one generally curved tank module and at least one generally rectangular tank module.

11. The remote load coupling and orientation control apparatus of claim 1, further comprising a power source for powering the propulsion device.

12. The remote load coupling and orientation control apparatus of claim 1, further comprising a frame member coupled to the closed loop tank assembly.

13. The remote load coupling and orientation control apparatus of claim 1, wherein the closed loop tank assembly defines a frame member.

14. The remote load coupling and orientation control apparatus of claim 1, further comprising a transmitter for transmitting a wireless signal to a device, wherein the wireless signal corresponds to a position of an element of the remote load coupling and orientation control apparatus.

15. The remote load coupling and orientation control apparatus of claim 1, further comprising a receiver for receiving a wireless signal from a device, wherein the wireless signal corresponds to instructions for operation of the remote load coupling and orientation control apparatus.

16. A method of connecting a remote load coupling and orientation control apparatus to a load, comprising:
providing a remote load coupling and orientation control apparatus comprising:
a closed loop tank assembly comprising a plurality of tank modules, wherein a fluid is positioned within the closed loop tank assembly;
a propulsion device for controlling a direction and a speed of the fluid positioned within the closed loop tank assembly;
a power source for powering the propulsion device;
a plurality of locking systems for coupling the remote load coupling and orientation control apparatus to a load;
positioning the remote load coupling and orientation control apparatus such that each locking system is positioned within a chamber of the load;
actuating each lifting connection from an unsecured position to a secured position within the chamber;
lifting the load by lifting the remote load coupling and orientation control apparatus when each locking system is in the secured position such that the remote load coupling and orientation control apparatus is coupled to the load; and
activating the propulsion device for controlling the orientation of the lifted load.

17. The method of claim 16, wherein the propulsion device is an impeller or a propeller.

18. The method of claim 16, wherein the remote load coupling and orientation control apparatus further comprises a frame member coupled to the closed loop tank assembly .

19. The method of claim 16, wherein the step of actuating the propulsion device for controlling the orientation of the lifted load further comprises:
receiving, by a transceiver, a signal from a remote device corresponding to an instruction to rotate the propulsion device in a desired direction at a desired rate;
sending, by a controller, a signal to the propulsion device to rotate in the desired direction at the desired rate.

20. The method of claim 16, further comprising:
detecting the position of the locking systems;
transmitting a wireless signal to a remote device, the wireless signal corresponding to the position of the lifting connection;
displaying an indication on the remote device corresponding to the position of the lifting connection.

21. The method of claim 19, wherein the step of actuating the propulsion device for controlling the orientation of the lifted load further comprises actuating the propulsion device for positioning the lifted load in a desired position relative to a lowering location; and
lowering the lifted load in the desired position onto the lowering location.

22. The method of claim 21, wherein the desired position of the lifted load is defined relative to a size and a shape of the lowering location.

23. The method of claim 20, wherein the step of actuating the propulsion device for controlling the orientation of the lifted load further comprises actuating the propulsion device for maintaining a desired orientation of the lifted load relative to a lowering location; and
lowering the lifted load in the desired orientation onto the lowering location.

24. The method of claim 19, wherein the remote device is a mobile telephone, a handheld device, or a computing device.

25. The method of claim 19, wherein the propulsion device comprises a propeller, an impeller, a plurality of propellers, a plurality of impellers, or a combination of one or more propellors and one or more impellers.

26. A load coupling and orientation control apparatus comprising:
a closed loop tank assembly, wherein a fluid is positioned within the closed loop tank assembly;
a propulsion device for controlling a direction and a speed of the fluid positioned within the closed loop tank assembly to thereby control orientation of the closed loop tank assembly; and
a plurality of locking systems for coupling the load coupling and orientation control apparatus to a load.

27. The load coupling and orientation control apparatus of claim 26 further comprising a controller coupled to the propulsion device and adapted to receive and send wireless signals to a remote control device.

28. The load coupling and orientation control apparatus of claim 26, wherein the closed loop tank assembly comprises a plurality of tank modules connected to one another.

29. The load coupling and orientation control apparatus of claim 28, wherein the closed loop tank assembly has a generally rounded rectangular shape, a generally circular shape, or a generally elliptical shape.

30. The load coupling and orientation control apparatus of claim 26, wherein the propulsion device comprises a propeller, an impeller, a plurality of propellers, a plurality of impellers, or a combination of one or more propellers and one or more impellers.

31. The load coupling and orientation control apparatus of claim 26, wherein the load coupling and orientation control apparatus is adapted to move in a counterclockwise direction in response to movement of the fluid in a clockwise direction.

32. The load coupling and orientation control apparatus of claim 26, wherein the load coupling and orientation control apparatus is adapted to move in a clockwise direction in response to movement of the fluid in a counterclockwise direction.
